(19) United States
(12) Patent Application Publication
(10) Pub. No.: US 2023/0406087 A1
(43) Pub. Date: Dec. 21, 2023

(54) MOUNT DESIGN WITH INTEGRATED TUNABLE RETENTION FEATURES

(71) Applicant: ContiTech Vibration Control GmbH, Hannover (DE)

(72) Inventor: Scott Bykowski, Hyland, MI (US)

(73) Assignee: ContiTech Vibration Control GmbH, Hannover (DE)

(21) Appl. No.: 18/249,065

(22) PCT Filed: Sep. 13, 2021
(86) PCT No.: PCT/EP2021/075083

§ 371 Date: Apr. 14, 2023

Related U.S. Application Data
(60) Provisional application No. 63/091,499, filed on Oct. 14, 2020.

(51) Int. Cl. B60K 5/12; F16F 1/36

(52) U.S. Cl. CPC B60K 5/1208; F16F 1/3615

(57) ABSTRACT

A mount assembly includes a mount, a vibration mitigation element and a retention feature. The vibration mitigation element is within a portion of the mount. The retention feature is configured to cover an end of the vibration mitigation element, wherein the retention feature is tunable to provide a selected precompression of the vibration mitigation element and a selected rate for the vibration mitigation element.

### FIELD

The field to which the disclosure generally to vehicles and mounts.

### BACKGROUND

Vehicles typically include mounts that couple various parts together. For example, an engine mount is the part that holds an engine to the frame of a car/vehicle. A transmission mount holds a transmission to the vehicle. Other types of mounts are also included in vehicles.

What is needed is an improved engine mount.

### BRIEF DESCRIPTION OF THE DRAWINGS

FIG. 1 is a diagram illustrating a mount assembly 100 in accordance with one or more embodiments.

FIG. 2 is a diagram illustrating a mount assembly 200 in accordance with one or more embodiments.

FIG. 3 is a diagram illustrating a mount assembly 300 in accordance with one or more embodiments.

FIG. 4 is a diagram illustrating a mount assembly 400 in accordance with one or more embodiments.

FIG. 5 is a diagram illustrating a mount assembly 500 in accordance with one or more embodiments.

FIG. 6 is a diagram illustrating the mount assembly 500 in accordance with one or more embodiments.

FIG. 7 is a diagram illustrating the retention feature 102 in accordance with one or more embodiments.

FIG. 8 is a diagram illustrating the retention feature 102 in accordance with one or more embodiments.

### DETAILED DESCRIPTION

The following description of the variations is merely illustrative in nature and is in no way intended to limit the scope of the disclosure, its application, or uses. The description is presented herein solely for the purpose of illustrating the various embodiments of the disclosure and should not be construed as a limitation to the scope and applicability of the disclosure. In the summary of the disclosure and this detailed description, each numerical value should be read once as modified by the term “about” (unless already expressly so modified), and then read again as not so modified unless otherwise indicated in context. Also, in the summary of the disclosure and this detailed description, it should be understood that a value range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors had possession of the entire range and all points within the range.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Also, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Also, in some example embodiments, well-known processes, well-known device structures, and well-known technologies are not described in detail. Further, it will be readily apparent to those of skill in the art that in the design, manufacture, and operation of apparatus to achieve that described in the disclosure, variations in apparatus design, construction, condition, erosion of components, gaps between components may present, for example.

Typically, an engine and transmission are bolted together and held in place in a vehicle by a number of mounts referred to as engine mounts and transmission mounts.

These mounts serve to hold the engine and transmission in place while reducing vibration.

Excessive vibration can cause damage to the vehicle and/or engine.

One or more embodiments are disclosed that include an engine mount without bonding, use radial precompression and/or incorporate a locking retention feature having a tunable geometry for alternate rate buildup.

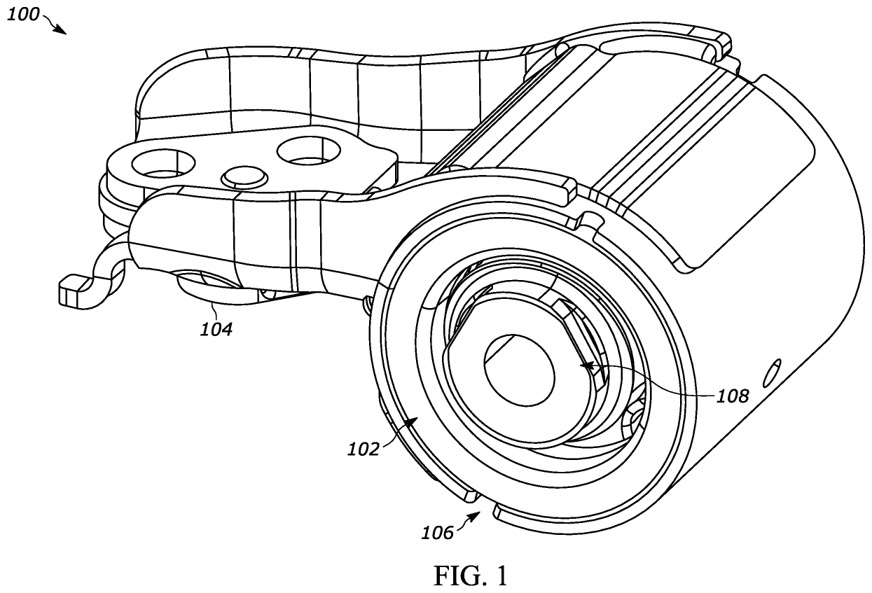

FIG. 1 is a diagram illustrating a mount assembly 100 in accordance with one or more embodiments. It is appreciated that the assembly 100 is provided for illustrative purposes and that suitable variations are contemplated.

The assembly 100 includes a mount 104 and a retention feature 102. A connection element or part 108 is also shown. The assembly 100 couples or connects the mount 104 with the part 108 by way of a bushing and/or the like.

The mount 104 can be an engine mount and is comprised of a suitable materials, such as steel, iron, metal and/or the like.

The retention feature 102 can also be referred to as an end cap. The retention feature 102 may be formed from a mixture containing any suitable thermoset polymeric material and/or thermoplastic polymeric material. Some non-limiting examples of such polymeric materials include aliphatic polyamides, such as PA46, PA66, PA6, PA610, and PA11, and the like, aromatic polyamides, aromatic polyimides, and aliphatic polyimides. In some aspects of the disclosure, the mixture used to form the retention feature 102 may further include fillers, fibers, pigments, curatives, processing aids, solvents, or any other suitable materials known to those in the art.

The retention feature 102 provides and/or facilitates no bonding and radial precompression. The retention feature 102 includes a tunable geometry for alternate rate buildup. The retention feature 102 is lockable to secure and/or set the rate buildup.

The retention feature 102 also includes a detent 106 to prevent rotation of the feature 102 after insertion. The detent 106 fits into a gap or slot of the mount 104.

The retention feature 102 caps an element or busing within the assembly 100 that attaches the part 108 and the mount 104. The element or bushing can be comprised of rubber or an elastomeric material.

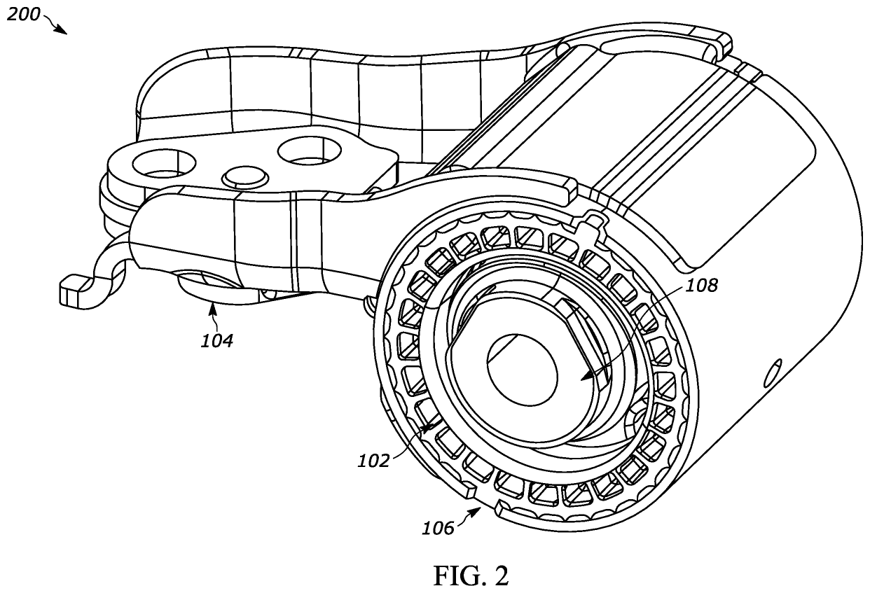

FIG. 2 is a diagram illustrating a mount assembly 200 in accordance with one or more embodiments. It is appreciated that the assembly 200 is provided for illustrative purposes and that suitable variations are contemplated.

The assembly 200 is substantially similar to the assembly 100.

Here, the retention feature 102 is not solid or of an open design.

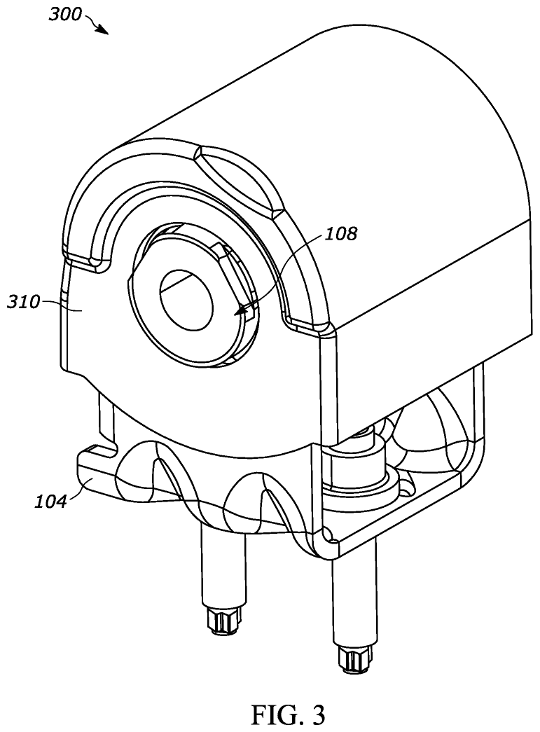

FIG. 3 is a diagram illustrating a mount assembly 300 in accordance with one or more embodiments. It is appreciated that the assembly 300 is provided for illustrative purposes and that suitable variations are contemplated.

The assembly 300 is substantially similar to the assembly 100.

The mount 104 has a different configuration.

A shield 310 is configured to cover and protect at least a portion of the mount 104 and the retention feature 102.

FIG. 4 is a diagram illustrating a mount assembly 400 in accordance with one or more embodiments. It is appreciated that the assembly 400 is provided for illustrative purposes and that suitable variations are contemplated.

The assembly 400 is substantially similar to the assembly 300, however the shield 310 has been removed.

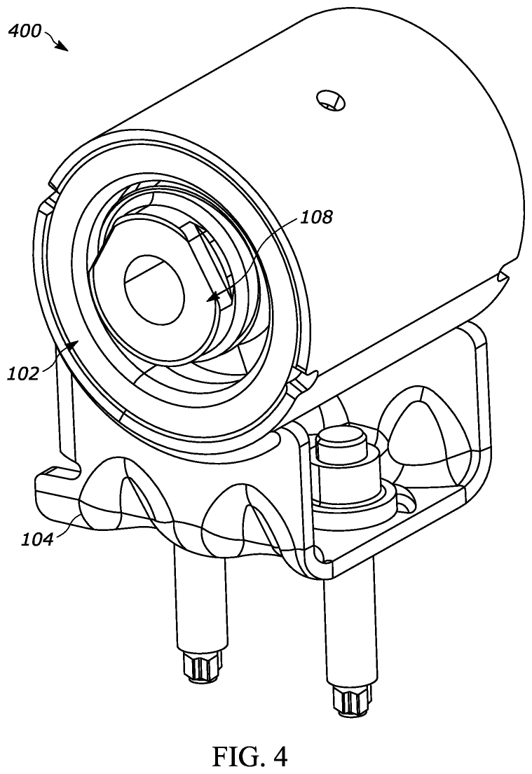

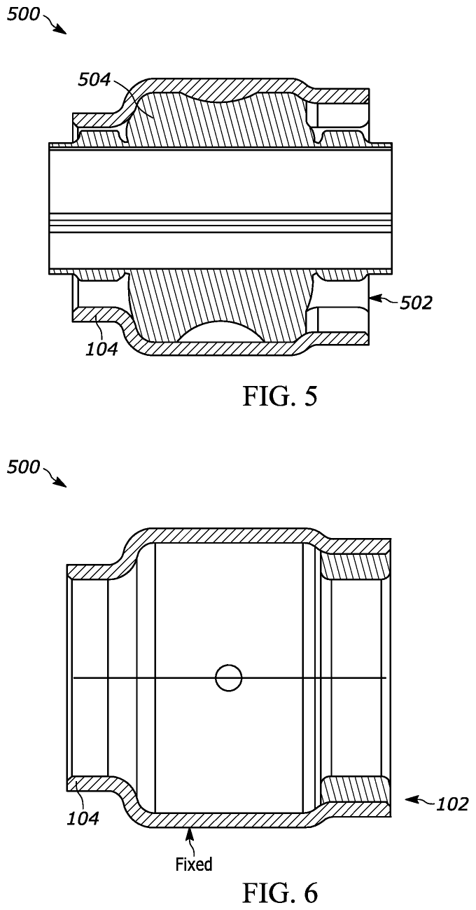

FIG. 5 is a diagram illustrating a mount assembly 500 in accordance with one or more embodiments. It is appreciated that the assembly 500 is provided for illustrative purposes and that suitable variations are contemplated.

The assembly 500 is substantially similar to the assembly 100.

The assembly 500 is shown with a bushing or vibration element 504.

The retention feature 102 permits no bonding and radial precompression of the element 504.

FIG. 6 is a diagram illustrating the mount assembly 500 in accordance with one or more embodiments. An outside view of the assembly 500 is shown.

The retention feature 102 applies a load as shown.

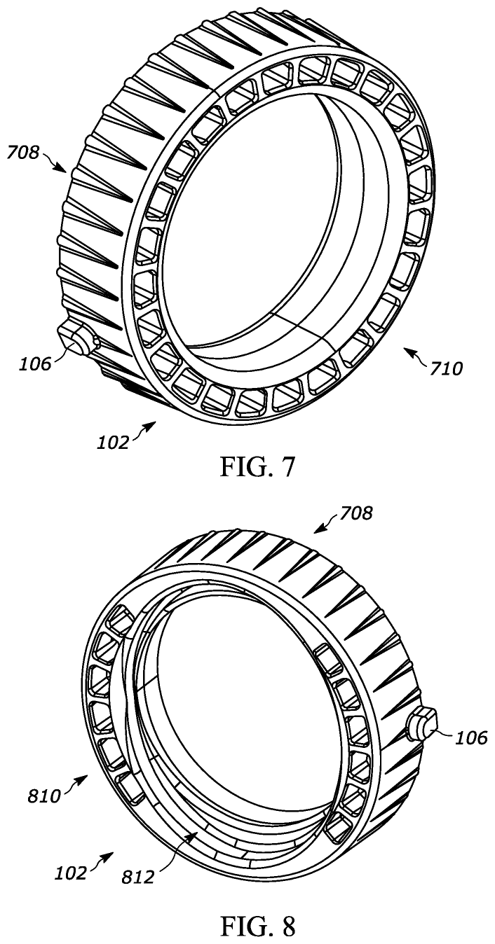

FIG. 7 is a diagram illustrating the retention feature 102 in accordance with one or more embodiments. It is appreciated that suitable variations are contemplated.

The retention feature 102 can be used with/in the above assemblies and variations thereof.

The retention feature 102 includes a detect 106 configured to prevent or mitigate rotation of the feature once installed.

The retention feature 102 also includes a retention mechanism 708, which includes a plurality of shaped ridges or protrusions configured to prevent or mitigate removal of the retention feature 102 from the mount 104.

The feature 102 is shown having openings formed therethrough from an inner side 710 to an outer side.

FIG. 8 is a diagram illustrating the retention feature 102 in accordance with one or more embodiments. It is appreciated that suitable variations are contemplated.

The feature 102 includes openings 810 in a first portion and various shapes and/or grooves 812 in a second portion. The first portion and the second portion are configured to provide a selected rate or pre-compression based on how the feature 102 is rotated upon insertion into the mount 104.

One general aspect includes an engine mount assembly. The assembly includes a mount having a cylindrical cavity portion; a vibration mitigation element within the cylindrical portion of the mount; and a retention feature configured to cover an end of the vibration mitigation element, where the retention feature is tunable to provide a selected precompression of the vibration mitigation element and a selected rate for the vibration mitigation element.

Implementations may include one or more of the following features. The assembly where the retention feature of a polymeric material. The vibration mitigation element is a bushing may include of rubber. The assembly may include a part connected to an interior or middle of the vibration mitigation element. The assembly may include that the mount may include a bay attachment portion attached and bolted to an engine bay of a vehicle and a connection element attached to an interior of the vibration mitigation element. The assembly may include the connection element being part of a vehicle engine. The assembly may include the retention feature being an end cap. The assembly may include the retention feature formed of a thermoset polymeric material. The assembly the thermoset polymeric material may include one or more of aliphatic polyamides, such as pa46, pa66, pa6, pa610, and pa11. The retention feature can be configured to compressibly attach a connection element to the mount without an adhesive. The retention feature is tunable by rotation to provide a set rate buildup. The retention feature being lockable. The assembly may include a cover that shields the retention feature and vibration mitigation element. The assembly retention feature having openings in a first portion and grooves in a second portion, the first portion and the second portion configured to provide a selected rate and/or pre-compression based on rotation of the feature when inserted into the mount. The thermoset polymeric material may include one or more of aromatic polyamides, aromatic polyimides, and aliphatic polyimides. The retention feature may include a detent configured to prevent rotation of the feature after installation. The mount may include of a material from a group may include steel and iron.

One general aspect includes a method of installing an engine mount assembly. The method of installing includes providing an engine mount having a cavity portion and an engine bay attachment and may include of metal. The method of installing also includes inserting a vibration mitigation element into the cavity portion of the engine mount. The method of installing also includes installing a polymeric retention feature to the engine mount to cover an end of the vibration mitigation element, where the retention feature is rotated to provide a selected precompression of the vibration mitigation element and a selected rate for the vibration mitigation element. The method of installing also includes locking the retention feature. The method of installing also includes attaching a connection element to the vibration mitigation element.

It is noted that ‘having’ does not exclude other elements or steps and ‘one’ or ‘one’ does not exclude a multitude. It should also be noted that characteristics described with reference to one of the above examples of execution can also be used in combination with other characteristics of other examples of execution described above. Reference signs in the claims are not to be regarded as a restriction.

Spatially relative terms, such as “inner”, “adjacent”, “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

1. An engine mount assembly comprising:
a mount having a cylindrical cavity portion;
a vibration mitigation element within the cylindrical portion of the mount; and
a retention feature configured to cover an end of the vibration mitigation element, wherein the retention feature is tunable to provide a selected precompression of the vibration mitigation element and a selected rate for the vibration mitigation element.

2. The assembly of claim 1, wherein the retention feature is comprised of a polymeric material.

3. The assembly of claim 1, wherein the vibration mitigation element is a bushing comprised of rubber.

4. The assembly of claim 1, further comprising a part connected to an interior or middle of the vibration mitigation element.

5. The assembly of claim 1, the mount comprising a bay attachment portion attached and bolted to an engine bay of a vehicle and a connection element attached to an interior of the vibration mitigation element.

6. The assembly of claim 1, the connection element being part of a vehicle engine.

7. The assembly of claim 1, the retention feature being an end cap.

8. The assembly claim 1, the retention feature formed of a thermoset polymeric material.

9. The assembly of claim 8, the thermoset polymeric material comprising one or more of aliphatic polyamides, such as PA46, PA66, PA6, PA610, and PA11.

10. The assembly of claim 8, the thermoset polymeric material comprising one or more of aromatic polyamides, aromatic polyimides, and aliphatic polyimides.

11. The assembly of claim 1, the retention feature configured to compressibly attach a connection element to the mount without an adhesive.

12. The assembly of claim 1, the retention feature is tunable by rotation to provide a set rate buildup.

13. The assembly of claim 12, the retention feature being lockable.

14. The assembly of claim 1, further comprising a cover that shields the retention feature and vibration mitigation element.

15. The assembly of claim 1, the retention feature comprising a detent configured to prevent rotation of the feature after installation.

16. The assembly of claim 1, the retention feature having openings in a first portion and grooves in a second portion, the first portion and the second portion configured to provide a selected rate and/or pre-compression based on rotation of the feature when inserted into the mount.

17. The assembly of claim 1, the mount comprised of a material from a group comprising steel and iron.

18. A method of installing an engine mount assembly, the method comprising:
providing an engine mount having a cavity portion and an engine bay attachment and comprised of metal;
inserting a vibration mitigation element into the cavity portion of the engine mount;
installing a polymeric retention feature to the engine mount to cover an end of the vibration mitigation element, wherein the retention feature is rotated to provide a selected precompression of the vibration mitigation element and a selected rate for the vibration mitigation element;
locking the retention feature; and
attaching a connection element to the vibration mitigation element.

19. The method of claim 18, further comprising bolting the engine bay attachment of the mount to an engine bay of a vehicle.

20. The method of claim 18, further comprising providing the retention feature as a detent and preventing rotation after installation.
